(19) United States
(12) Patent Application Publication
(10) Pub. No.: US 2024/0272850 A1
(43) Pub. Date: Aug. 15, 2024

(54) PRINTER, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventor: TATEKI NARITA, Tokyo (JP)

(21) Appl. No.: 18/435,105

(22) Filed: Feb. 7, 2024

(30) Foreign Application Priority Data
Feb. 14, 2023 (JP) 2023-020847

(51) Int. Cl. G06F 3/12

(52) U.S. Cl. CPC G06F 3/1263; G06F 3/1207

(57) ABSTRACT

A printer capable of maximally executing a print job in which a time period for executing printing is designated. The printer includes a reception unit that receives a print job in which an execution time period for executing printing is designated, an execution unit that executes the print job, an obtainment unit that obtains a required time required for execution of the print job, and a determination unit that determines an execution timing of the print job within a printable time period in which the print job is executable by the execution unit based on the execution time period and the required time, in a case where the printable time period overlaps the execution time period.

### BACKGROUND OF THE INVENTION

### Field of the Invention

The present invention relates to a printer, a control method therefor, and a storage medium storing a control program therefor.

### Description of the Related Art

Conventionally, a printer that receives print data from a communication terminal via a network and prints an image on a sheet on the basis of the received print data is known. The print data is generated using a model-dependent printer driver or a model-dependent print application corresponding to each printer.

In recent years, a method of generating a print job by a printer driver on the basis of a standard specification without using such a model-dependent printer driver or a model-dependent print application is known. As a printer driver based on the standard specification, a printer driver that operates based on an industry standard protocol, such as IPP (Internet Printing Protocol), is used. In the IPP protocol, the specification is extended for an industrial printer. The specification extension includes, for example, a function of adjusting the execution order of print jobs by queuing the print jobs for which print job completion times are designated.

In a field of industrial printing, a customer orders a print service from a print company by sending print data with designating a delivery deadline. The print company manages a printing schedule to meet the delivery deadline of the print job requested by each customer. Japanese Laid-Open Patent Publication (Kokai) No. 2013-49223 discloses an information terminal capable of transmitting print data in which an execution time for executing a print job is designated in transmitting the print data to a printer (an image forming apparatus). Moreover, the printer in this publication can execute a print job based on the execution time.

However, in the print company, delivery deadlines may be crowded, and other print jobs may be reserved at the designated time. In such a case, the printer cannot accept the job. As a result, the print company must change the designated time and reenter the job.

### SUMMARY OF THE INVENTION

The present invention provides a mechanism capable of maximally executing a print job in which a time period for executing printing is designated.

Accordingly, an aspect of the present invention provides a printer including a reception unit configured to receive a print job in which an execution time period for executing printing is designated, an execution unit configured to execute the print job, an obtainment unit configured to obtain a required time required for execution of the print job, and a determination unit configured to determine an execution timing of the print job within a printable time period in which the print job is executable by the execution unit based on the execution time period and the required time, in a case where the printable time period overlaps the execution time period.

According to the present invention, it is possible to maximally execute a print job in which a time period for executing printing is designated.

Further features of the present invention will become apparent from the following description of exemplary embodiments with reference to the attached drawings.

### BRIEF DESCRIPTION OF THE DRAWINGS

FIG. 1 is a block diagram showing a hardware configuration of a terminal apparatus.

FIG. 2 is a block diagram showing a hardware configuration of a printer.

FIG. 3A is a view showing an example of a print setting screen in the terminal apparatus.

FIG. 3B is a view showing a modification of the print setting screen in the terminal apparatus.

FIG. 4A and FIG. 4B are views for describing processes of print jobs in a case where print start times are overlappingly designated.

FIG. 5 is a view showing a configuration example of a printing system including the terminal apparatus and the printer.

FIG. 6A is a view showing an example of a print setting screen (time period designation) in the terminal apparatus.

FIG. 6B is a view showing a modification of the print setting screen (time period designation) in the terminal apparatus.

FIG. 7A and FIG. 7B are views for describing processes of print jobs in a case where print start time periods are overlappingly designated.

FIG. 7C and FIG. 7D are views for describing processes of print jobs in a case where print end time periods are overlappingly designated.

FIG. 8A is a flowchart showing a process executed by the printer.

FIG. 8B is a flowchart showing a part of the process in a step S807 (subroutine) in the flowchart shown FIG. 8A.

FIG. 8C is a flowchart showing the remainder of the process in the step S807 (subroutine) of the flowchart shown in FIG. 8A.

FIG. 9 is a flowchart showing the process in step S815 (subroutine) of the flowchart shown in FIG. 8A.

FIG. 10 is a flowchart showing a process in a case where there is a print job in which execution start is restricted.

### DESCRIPTION OF THE EMBODIMENTS

Hereafter, embodiments according to the present invention will be described in detail by referring to the drawings. However, the configurations described in the following embodiments are merely examples, and the scope of the present invention is not limited by the configurations described in the embodiments. For example, each unit constituting the present invention can be replaced with any configuration capable of exhibiting the same function. In addition, an arbitrary constituent may be added.

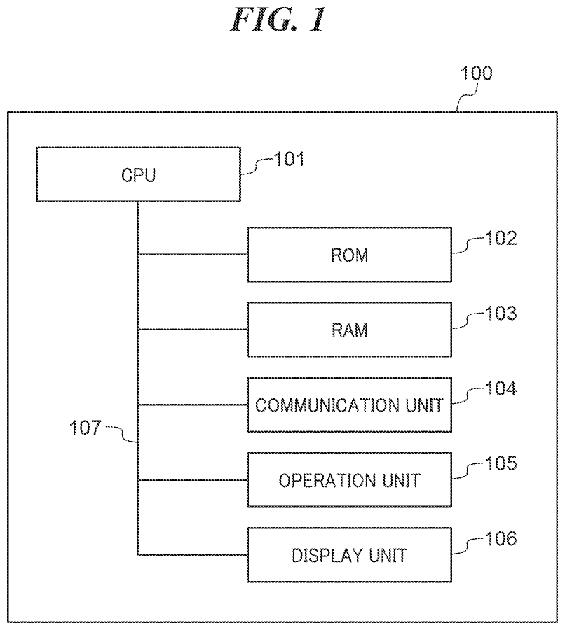

FIG. 1 is a block diagram showing a hardware configuration of a terminal apparatus. As shown in FIG. 1, the terminal apparatus 100 includes a CPU 101, a ROM 102, a RAM 103, a communication unit 104, an operation unit 105, and a display unit 106, which are communicably connected to each other via a bus 107. The CPU 101 is a computer that executes a program stored in the RAM 103. Thus, the CPU 101 can read and write data according to an instruction of the program. The ROM 102 is a nonvolatile memory. The RAM 103 is a volatile memory.

The CPU 101 can read the date in the ROM 102 into the RAM 103. The ROM 102 stores programs to be executed by the CPU 101, various kinds of data, etc. The communication unit 104 is a communication module functions according to a wired (Ethernet) or wireless (Wi-Fi (registered trademark)) standard.

The terminal apparatus 100 can communicate with a printer 200 via the communication unit 104. The operation unit 105 is constituted by, for example, a keyboard, a mouse, a touch panel, etc. The CPU 101 can detect an instruction from the user input via the operation unit 105. The display unit 106 can display, for example, information about various applications. The terminal apparatus 100 is not particularly limited, and examples thereof include a desktop or notebook personal computer, a tablet terminal, and a smartphone.

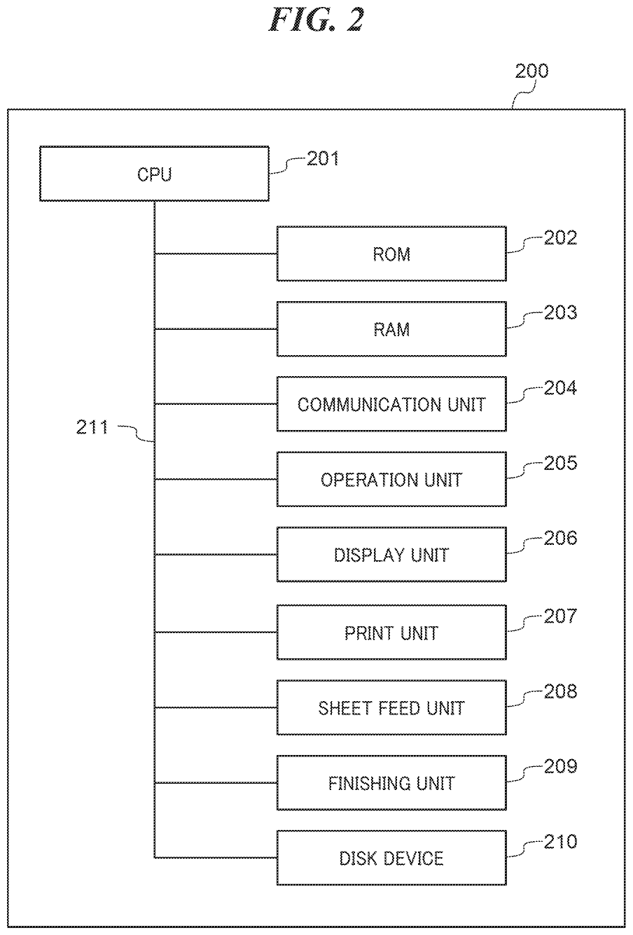

FIG. 2 is a block diagram showing a hardware configuration of the printer 200. As shown in FIG. 2, the printer 200 includes a CPU 201, a ROM 202, a RAM 203, a communication unit 204, an operation unit 205, a print unit 207, a sheet feed unit 208, a finishing unit 209, and a disk device 210, which are communicably connected to each other via a bus 211. The CPU 201 is a computer that executes a program stored in the ROM 203. Thus, the CPU 201 can read and write data according to an instruction of the program. The ROM 202 is a nonvolatile memory. The RAM 203 is a volatile memory.

The CPU 201 can read the date in the ROM 202 into the RAM 203. The ROM 202 stores programs to be executed by the CPU 201, various kinds of data. The programs are not particularly limited, and for example, a program for causing the CPU 201 to execute each unit of the printer 200 (a control method of the printer) is included. The communication unit 204 is a communication module functions according to a wired (Ethernet) or wireless (Wi-Fi) standard.

The printer 200 can communicate with the terminal apparatus 100 via the communication unit 204. This enables the printer 200 to receive a print job (print document) from the terminal apparatus 100 (a reception step). As described above, in this embodiment, the communication unit 204 functions as a reception unit configured to receive a print job. The operation unit 205 is configured by, for example, a touch panel, a mechanical button, etc. The CPU 201 can detect an instruction from the user input via the operation unit 205. The display unit 206 can display, for example, the state of the printer 200.

The print unit 207 has an ink ejecting unit of an ink jet system, a toner transfer unit of an electrophotographic system, or the like. Thus, the print unit 207 can execute the print job received from the terminal apparatus 100 via the communication unit 204 and perform printing on a print sheet (a print step). In the print job, a time period (hereinafter, referred to as an “execution time period”) in which the printing execution in the print unit 207 is desired is designated.

The sheet feed unit 208 supplies, that is, feeds a print sheet, such as a cut sheet or a roll sheet, to the print unit 207. The finishing unit 209 performs a finishing process on the sheet printed by the print unit 207. The finishing unit 209 includes, for example, a stapler that binds printed sheets one by one with a staple, a cutter that cuts printed roll paper at a designated position, and a laminator that laminates printed sheets. The finishing unit 209 can also apply transparent ink to the printed sheet for the purpose of giving a glossy appearance or improving weather resistance. The finishing process may be omitted.

The disk device 210 is a mass storage device, such as a hard disk drive (HDD) or a solid state drive (SSD). The disk device 210 can store a print job and the like transmitted from the terminal apparatus 100. The printer 200 can obtain a print-job required time required for executing a print job by prediction (an obtainment step).

Although the CPU 201 functions as the obtainment unit that obtains the print-job required time in this embodiment, this is not limiting. For example, a section that functions as the obtainment unit may be provided separately from the CPU 201. The print-job required time may include a time until the printed sheet is output through the finishing unit 209. The CPU 201 can calculate the print-job required time on the basis of the number of pages to be printed, a data size, print settings, and the like in the print job. The calculation result is stored in, for example, the disk device 210. The printer 200 is not particularly limited, and may be, for example, an MFP having a facsimile function and a scanner function in addition to a printer function, or an SFP having a printer function only.

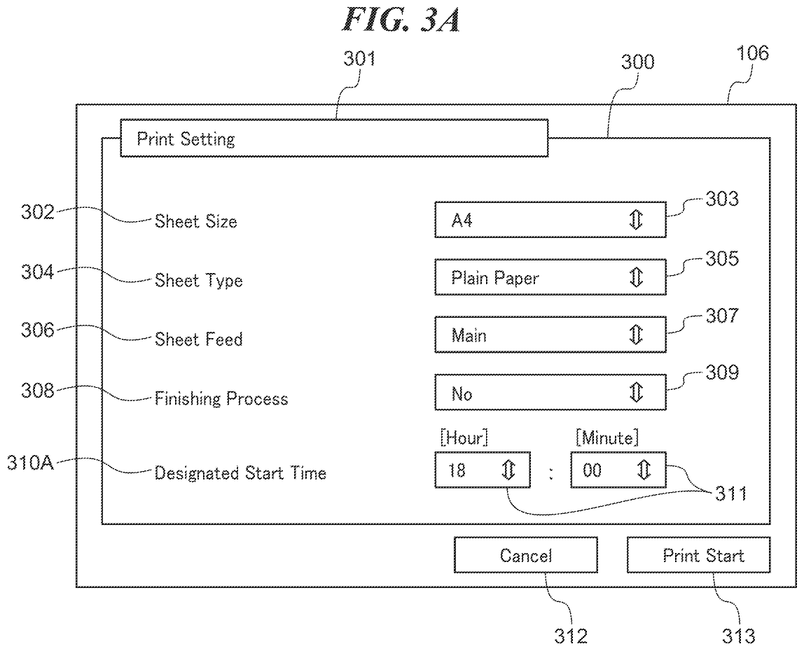

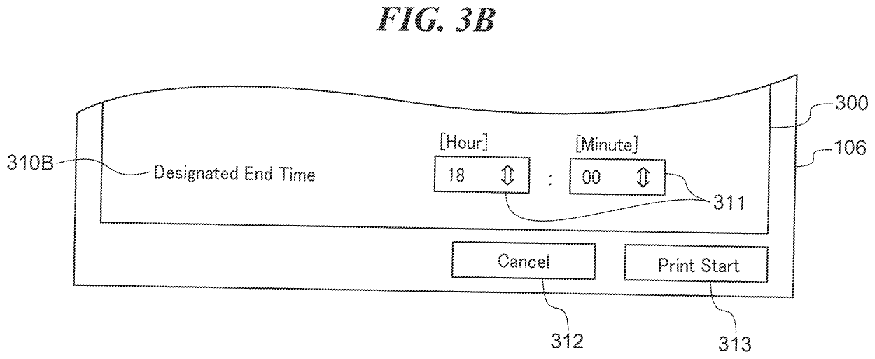

FIG. 3A is a view showing an example of a print setting screen in the terminal apparatus. The print setting screen 300 shown in FIG. 3A is displayed on the display unit 106 of the terminal apparatus 100. The print setting screen 300 includes a setting display switching menu 301, a sheet size selection 302, a drop-down 303, a sheet type setting 304, a drop-down 305, a sheet feed unit setting 306, and a drop-down 307. The print setting screen 300 further includes a finishing process setting 308, a drop-down 309, a designated start time setting 310A, drop-downs 311, a cancel button 312, and a print start button 313.

The setting display switching menu 301 can switch various settings, such as detailed settings and maintenance, in addition to the print settings. In the sheet size selection 302, the user can select the sheet size by selecting the drop-down 303. For example, in the drop-down 303, an A4 size is set as an initial value, and the sheet size can be arbitrarily changed to a sheet size that can be handled by the printer 200.

In the sheet type setting 304, the type of a sheet can be changed by selecting the drop-down 305. For example, in the drop-down 305, the initial value is set to a plain sheet, and the sheet type can be arbitrarily changed to a sheet type that can be handled by the printer 200. In the sheet feed unit setting 306, the sheet feed port from which a sheet is supplied to the print unit 207 can be changed by selecting the drop-down 307.

In the finishing process setting 308, the finishing process can be changed by selecting the drop-down 309. For example, in the drop-down 309, the initial value is set to “No” (the finishing process is not performed), and the finishing process can be arbitrarily changed to a finishing process that can be handled by the printer 200.

In the designated start time setting 310A, the start time at which the print job is started in the printer 200 can be set or changed by selecting the drop-down 311. When the start time is not set, a blank is selected in the drop-down 311. When the cancel button 312 is operated, transmission of the print job can be canceled. When the print start button 313 is operated, a print job is transmitted to the printer 200.

FIG. 3B is a view showing a modification of the print setting screen in the terminal apparatus. The print setting screen 300 shown in FIG. 3B includes a designated end time setting 310B. In the designated end time setting 310B, the end time at which the print job is ended in the printer 200 can be set or changed by selecting the drop-down 311. When the end time is not set, a blank is selected in the drop-down 311.

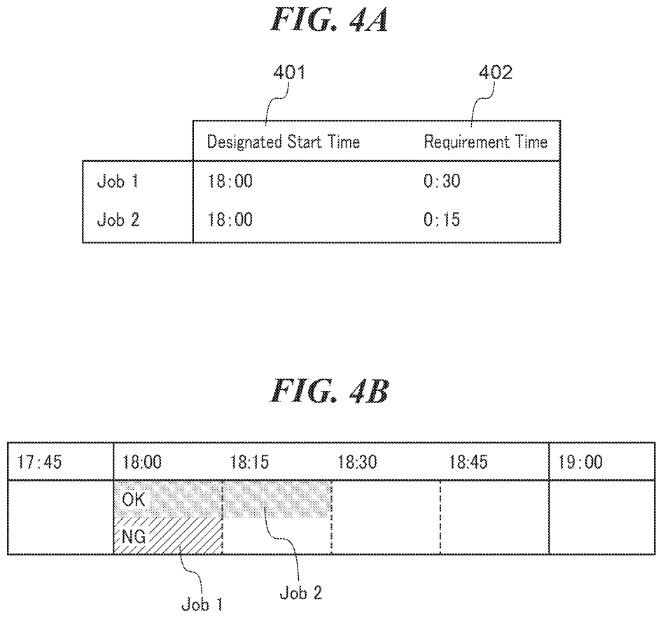

FIG. 4A and FIG. 4B are views for describing processes of print jobs in a case where print start times are overlappingly designated. In the state shown in FIG. 4A, the printer 200 receives the print job 1 and the print job 2 in this order. The print start time 401 of the print job 1 is designated as “18:00”, and the print start time 401 of the print job 2 is designated as “18:00”. The print start times 401 of the print jobs 1 and 2 are the same, that is, are overlapped. The required time 402 of the print job 1 is “30 minutes”, and the required time 402 of the print job 2 is “15 minutes”. The “required time 402” is a time required for the printer 200 to execute the print job, that is, a print job required time obtained by predicting a time required for outputting the printed document from the finishing unit 209.

In the timing chart shown in FIG. 4B, the execution of the print job 1 is started at “18:00” of the print start time designated in advance, and the execution is ended at “18:30” after the required time “30 minutes”. In contrast, the execution of the print job 2 should be started at the print start time “18:00” designated in advance, but the execution of the print job 1 has been started at this time, and therefore, the start of the execution of the print job 2 is restricted.

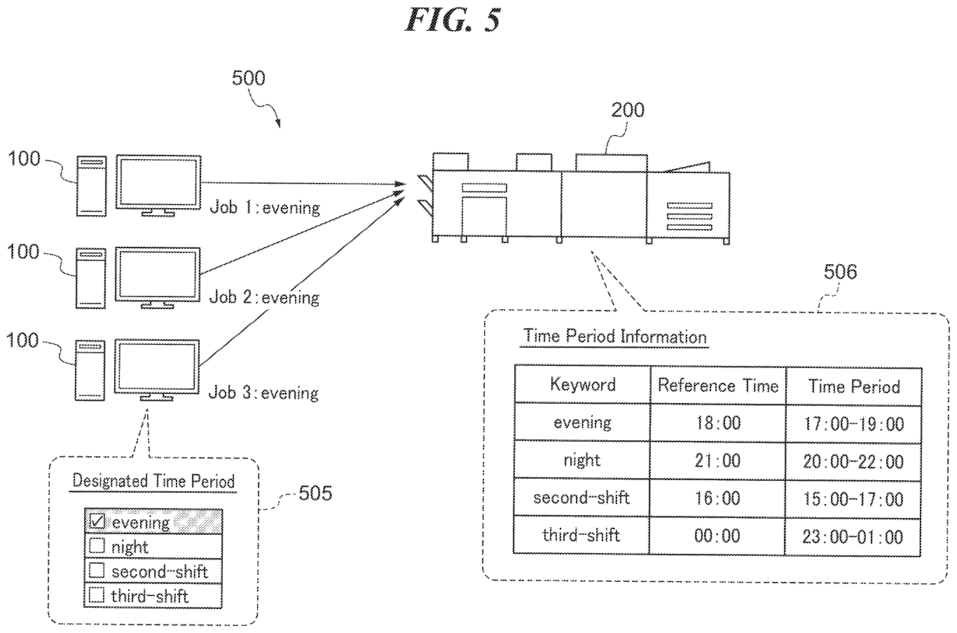

FIG. 5 is a view showing a configuration example of a printing system including the terminal apparatuses 100 and the printer 200. As shown in FIG. 5, the printing system 500 includes the first, second, and third terminal apparatuses 100 and the printer 200.

The printer 200 is communicably connected to the terminal apparatuses 100. As a result, the print job 1 is transmitted from the first terminal apparatus 100 to the printer 200, the print job 2 is transmitted from the second terminal apparatus 100 to the printer 200, and the print job 3 is transmitted from the third terminal apparatus 100 to the printer 200.

Each of the terminal apparatuses 100 can set a designated time period 505 during which printing is executed by the printer 200 in each print job. Here, the “designated time period 505” is a time having a width (an execution time period) and is expressed by selecting one of keywords, such as “evening”, “night”, “second shift”, and “third shift”.

The printer 200 stores time period information 506 in a storage unit, such as the ROM 202 or the disk device 210. The “time period information 506” is information relating to a printable time period in which the printer 200 can perform printing and corresponds to the designated time period 505 set in the print job.

In this embodiment, the designated time periods 505 include “evening”, “night”, “second shift”, and “third shift” as keywords. In this case, the time period information 506 also includes “evening”, “night”, “second shift”, and “third shift” as keywords. The time period information 506 includes time periods (printable time periods) and reference times.

For example, when the keyword is “evening”, the time period is “17:00 to 19:00”, and the reference time is “18:00”. In addition, when the keyword is “night”, the time period is “20:00 to 22:00”, and the reference time is “21:00”. In this way, the printer 200 stores in advance the time period information 506 having the time periods (printable time periods). The time periods in the time period information 506 are set so as not to overlap at least partially. It should be noted that the time periods may partially overlap each other. In each time period, the central (middle) time of the time period is set as the reference time.

The print job 1 transmitted from the first terminal apparatus 100, the print job 2 transmitted from the second terminal apparatus 100, and the print job 3 transmitted from the third terminal apparatus 100 may overlap in the time period 505 (execution time period). In this case, the printer 200 can receive three print jobs whose time periods 505 overlap.

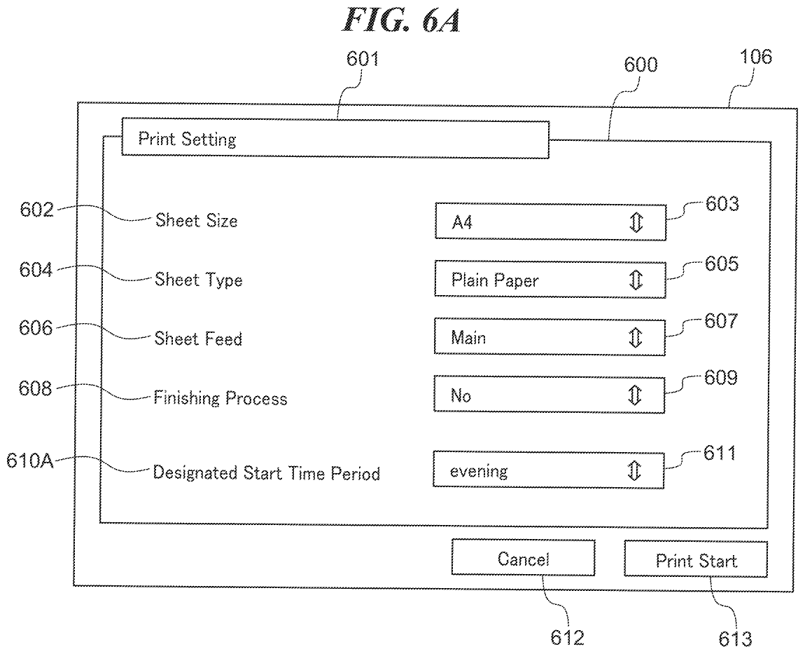

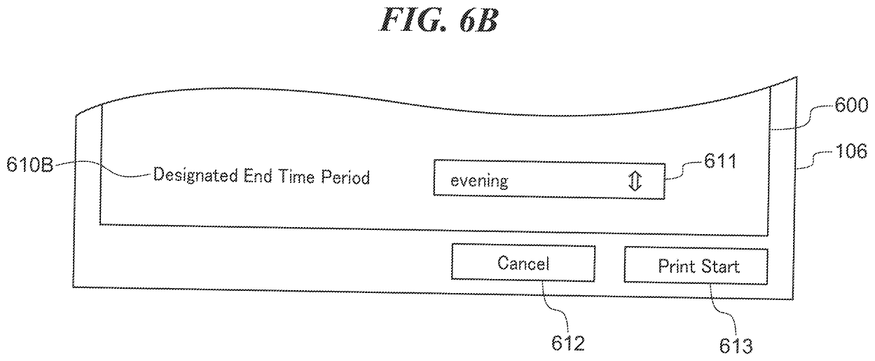

FIG. 6A is a view showing an example of a print setting screen for time period designation displayed in a terminal apparatus. The print setting screen 600 shown in FIG. 6A is displayed on the display unit 106 of the terminal apparatus 100. The print setting screen 600 includes a setting display switching menu 601, a sheet size selection 602, a drop-down 603, a sheet type setting 604, a drop-down 605, a sheet feed unit setting 606, and a drop-down 607.

The print setting screen 600 further includes a finishing process setting 608, a drop-down 609, a designated start time period setting 610A, a drop-down 611, a cancel button 612, and a print start button 613. The setting display switching menus 601 to the drop-down 609, the cancel button 612, and the print start button 613 are respectively similar to the setting display switching menus 301 to the drop-down 309, the cancel button 312, and the print start button 313 in FIG. 3.

In the designated start time setting 610A, the start time period in which the print job is started in the printer 200 can be set or changed using the time period expressed by the keyword like the “evening” by selecting the drop-down 611. When the start time period is not set, a blank is selected in the drop-down 611.

FIG. 6B is a view showing a modification of the print setting screen (time period designation) in the terminal apparatus. The print setting screen 600 shown in FIG. 6B includes a designated end time setting 610B. In the designated end time setting 610B, the end time period in which the print job is ended in the printer 200 can be set or changed using the time period expressed by the keyword like the “evening” by selecting a drop-down 611. When the end time period is not set, a blank is selected in the drop-down 611.

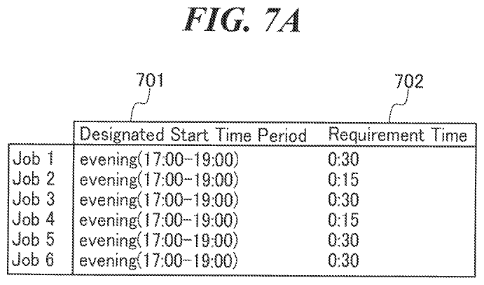

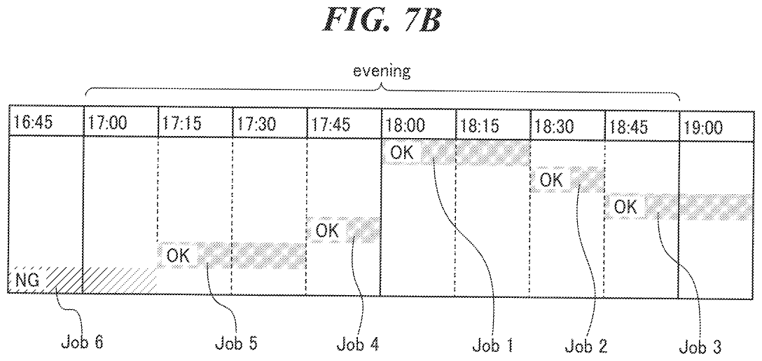

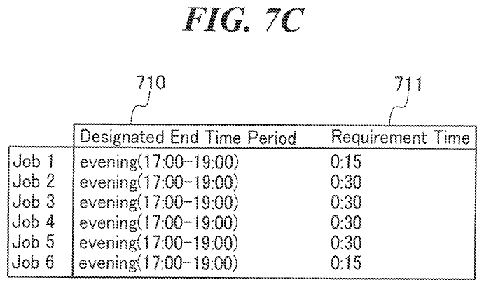

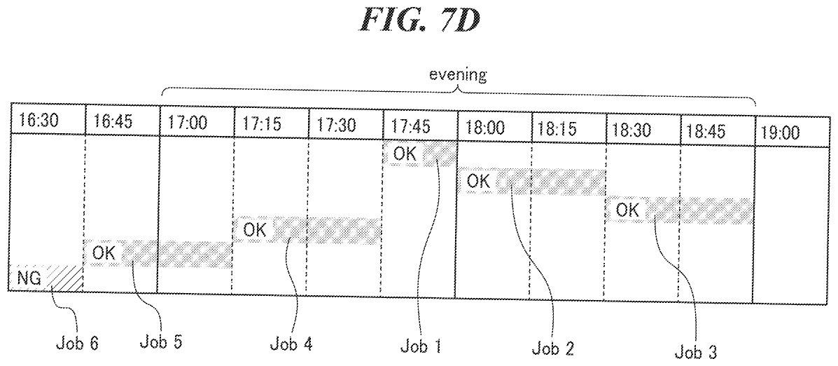

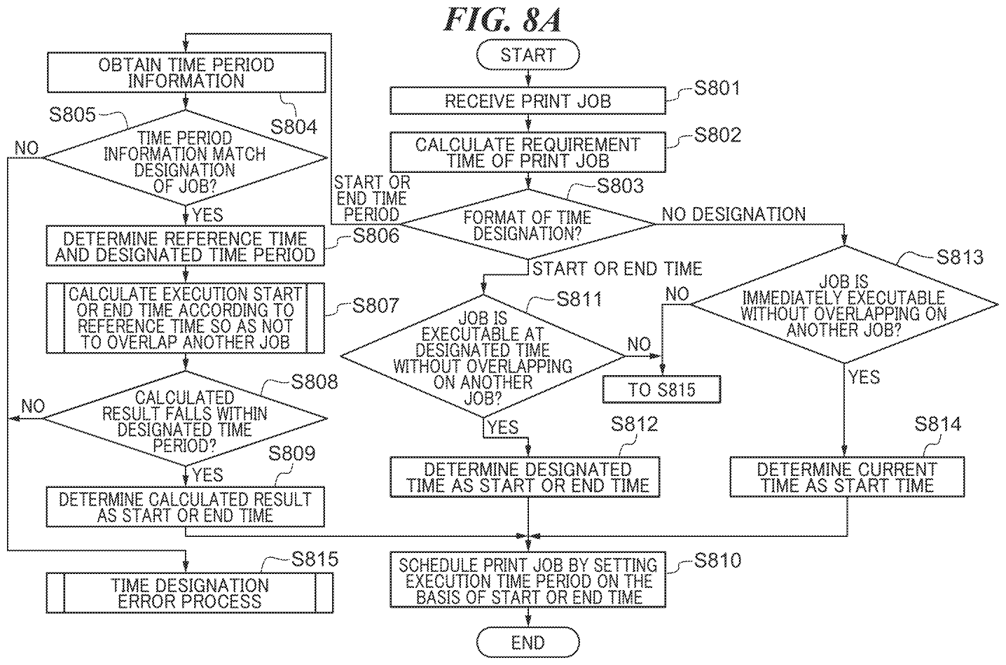

FIG. 7A and FIG. 7B are views for describing processes of print jobs in a case where print start time periods are overlappingly designated. In the state shown in FIG. 7A, the printer 200 receives a print job 1, a print job 2, a print job 3, a print job 4, a print job 5, and a print job 6 in this order. The print start time periods (execution time periods) 701 of the print job 1 to the print job 6 are designated by the keyword “evening”, and the print start time periods 701 (execution time periods) are the same, that is, overlap each other within the printable time period of the printer 200. As described above, when the keyword is the “evening”, the time period is “17:00 to 19:00” and the reference time is “18:00” (see the time period information 506 in FIG. 5).

Further, the required time (print-job required time) 702 of the print job 1 is “30 minutes”, the required time 702 of the print job 2 is “15 minutes”, and the required time 702 of the print job 3 is “30 minutes”. The required time 702 of the print job 4 is “15 minutes”, the required time 702 of the print job 5 is “30 minutes”, and the required time 702 of the print job 6 is “30 minutes”.

The printer 200 determines the start time at which the execution of each print job is started, that is, an execution timing of the print job within the printable time period, on the basis of the print start time period 701 and the required time 702 (a determination step). Although the CPU 201 of the printer 200 has the function as the determination unit for determining the start time of each print job in this embodiment, this is not limiting. For example, a section having the function as the determination unit may be provided in the printer 200 separately from the CPU 201.

In the timing chart shown in FIG. 7B, the execution of the print job 1 is started at the reference time “18:00” of the keyword “evening (17:00-19:00)”, and the execution is ended at “18:30” after the required time “30 minutes”. Since the print job 1 is being executed during “18:00 to 18:30” after the reference time “18:00” of the keyword “evening”, the execution of the print job 2 is started at “18:30” at which the execution of the print job 1 is ended.

In this way, it is determined so that the end time of the early print job 1 will overlap the start time of the latter print job 2 that is adjacent to the print job 1. This enables to narrow the execution interval between the print job 1 and the print job 2, and thus to start execution of as many print jobs as possible within the print start time period 701.

In the following, there are print jobs in the same state. The execution of the print job 2 is completed at “18:45” after the required time “15 minutes”. After the reference time “18:00” of the keyword “evening”, the print job 1 is being executed during “18:00 to 18:30”, and the print job 2 is being executed during “18:30 to 18:45”. Therefore, the execution of the print job 3 is started at “18:45” at which the execution of the print job 2 is ended, and the execution of the print job 3 is ended at “19:15” after the required time “30 minutes”.

After the reference time “18:00” of the keyword “evening”, the print job 1 to the print job 3 are being executed, and the end time “19:15” at which the execution of the print job 3 is ended is outside the time period of the keyword “evening”. Therefore, the execution of the print job 4 is started at “17:45” that is earlier than the reference time “18:00” at which the execution of the print job 1 is started by the required time “15 minutes”. The execution of the print job 4 is finished at “18:00” after the required time “15 minutes” from the start of the execution.

The execution of the print job 5 is started at “17:15” that is earlier than “17:45” at which the execution of the print job 4 is started by the required time “30 minutes”, and the execution of the print job 5 is ended at “17:45” that is later than the start of the execution by the required time “30 minutes”. The print job 6 is likely executed at “16:45” that is earlier than “17:15” at which the print job 5 is started by the required time “30 minutes”, but the execution start time is out of the time period of the keyword “evening”. Therefore, the start of execution of the print job 6 is restricted.

As described above, the printer 200 can determine the start time at which the print job starts so as to be included in the execution time period (time period 505) designated by the terminal apparatus 100 and in the printable time period (time period information 506) corresponding to the execution time period. Further, when the communication unit 204 receives a plurality of print jobs, the printer 200 determines the start times of the print jobs in the order of reception.

Specifically, the printer 200 first determines the start time of the print job 1 received first by the communication unit 204 among the print jobs 1 to 6 so as to be the reference time “18:00”. The start time of the print job 1 is not limited to be determined to the reference time “18:00”, and may be determined to be as close to the reference time “18:00” as possible, for example.

Next, the printer 200 finds the start times of the print job 2 and the print job 3 (other print jobs) after the print job 1 received first so as to fall within the time period after the reference time “18:00” or the time period before the reference time “18:00” while giving priority to the time period after the reference time. That is, the printer 200 first finds each of the start times so as to fall within the time period after the reference time, and if it is not found, finds each of the start times so as to fall within the time period before the reference time. Next, the start times of the remaining print jobs 4 and 5 are determined so as to fall within the time period before the reference time “18:00”. Such a determination enables that the start times of the print jobs 1 to 5 do not overlap in the execution time period.

As in this embodiment, when there are the print jobs 1 to 6 that overlappingly designate the same print start time period 701, the executions of the print jobs 1 to 5 among these print jobs 1 to 6 can be started within the print start time period 701. The print jobs 1 to 5 correspond to about 83% of the print jobs 1 to 6. This enables to execute the print jobs without omission as much as possible.

FIG. 7C and FIG. 7D are views for describing processes of the print jobs in a case where the print end time periods are overlappingly designated. In the state shown in FIG. 7C, the printer 200 receives a print job 1, a print job 2, a print job 3, a print job 4, a print job 5, and a print job 6 in this order. The print end time periods (execution time periods) 710 of the print job 1 to the print job 6 are designated by the keyword “evening”, and the print end time periods 710 (execution time periods) are the same, that is, overlap each other within the printable time period of the printer 200.

Further, the required time (print job required time) 711 of the print job 1 is “15 minutes”, the required time 711 of the print job 2 is “30 minutes”, and the required time 711 of the print job 3 is “30 minutes”. The required time 711 of the print job 4 is “30 minutes”, the required time 711 of the print job 5 is “30 minutes”, and the required time 711 of the print job 6 is “15 minutes”.

The printer 200 determines the end time at which execution of each print job is ended, that is, the execution timing of the print job within the printable time period, on the basis of the print end time period 710 and the required time 711 (the determination step). Although the CPU 201 of the printer 200 has the function as the determination unit for determining the end time of each print job in this embodiment, this is not limiting.

In the timing chart shown in FIG. 7D, the execution of the print job 1 is started at “17:45” that is earlier than the reference time “18:00” of the keyword “evening (17:00-19:00)” by the required time “15 minutes”. The execution of the print job 1 is finished at “18:00” after the required time “15 minutes” from the start of the execution. This end time overlaps the reference time “18:00”.

The execution of the print job 2 is started at “18:00” at which the execution of the print job 1 is finished, and the execution of the print job 2 is finished at “18:30” after the required time “30 minutes”. The execution of the print job 3 is started at “18:30” at which the execution of the print job 2 is finished, and the execution of the print job 3 is finished at “19:00” after the required time “30 minutes”. Further, the print job 2 and the print job 3 are executed after the reference time “18:00” of the keyword “evening”, and the print job 1 is executed in “17:45 to 18:00” before the reference time “18:00”.

Therefore, the execution of the print job 4 is started at “17:15” that is earlier than “17:45” at which the execution of the print job 1 is started by the required time “30 minutes”. The execution of the print job 4 is finished at “17:45” after the required time “30 minutes” from the start of the execution.

The execution of the print job 5 is started at “16:45” that is earlier than “17:15” at which the execution of the print job 4 is started by the required time “30 minutes”. The execution of the print job 4 is completed at “17:15” after the required time “30 minutes” from the start of the execution.

The execution of the print job 6 is likely started at “16:30” that is earlier than “16:45” at which the execution of the print job 5 is started by the required time “15 minutes”, and the execution of the print job 6 is likely ended at “16:45” after the required time “15 minutes”. However, the execution end time is outside the time period of the keyword “evening”. Therefore, the start of execution of the print job 6 is restricted.

As described above, the printer 200 can determine the end time at which the print job ends so as to be included in the execution time period (time period 505) designated by the terminal apparatus 100 and in the printable time period (time period information 506) corresponding to the execution time period.

Further, when the communication unit 204 receives a plurality of print jobs, the printer 200 determines the end times of the print jobs in the order of reception. Specifically, the printer 200 first determines the end time of the print job 1 received first by the communication unit 204 among the print jobs 1 to 6 so as to be the reference time “18:00”. The end time of the print job 1 is not limited to be determined to the reference time “18:00”, and may be determined to be as close to the reference time “18:00” as possible, for example.

Next, the printer 200 finds the end times of the print job 2 and the print job 3 (other print jobs) after the print job 1 received first so as to fall within the time period before the reference time “18:00” or the time period after the reference time “18:00” while giving priority to the time period after the reference time. Next, the end times at which the remaining print job 4 and print job 5 end are determined so as to fall within the time period before the reference time “18:00”. Such a determination enables that the end times of the print jobs 1 to 5 do not overlap in the execution time period.

As in this embodiment, when there are print jobs 1 to 6 that overlappingly designate the same print end time period 710, the execution of the print jobs 1 to 5 among these print jobs 1 to 6 can be ended within the print end time period 710. The print jobs 1 to 5 correspond to about 83% of the print jobs 1 to 6. This enables to execute the print jobs without omission as much as possible.

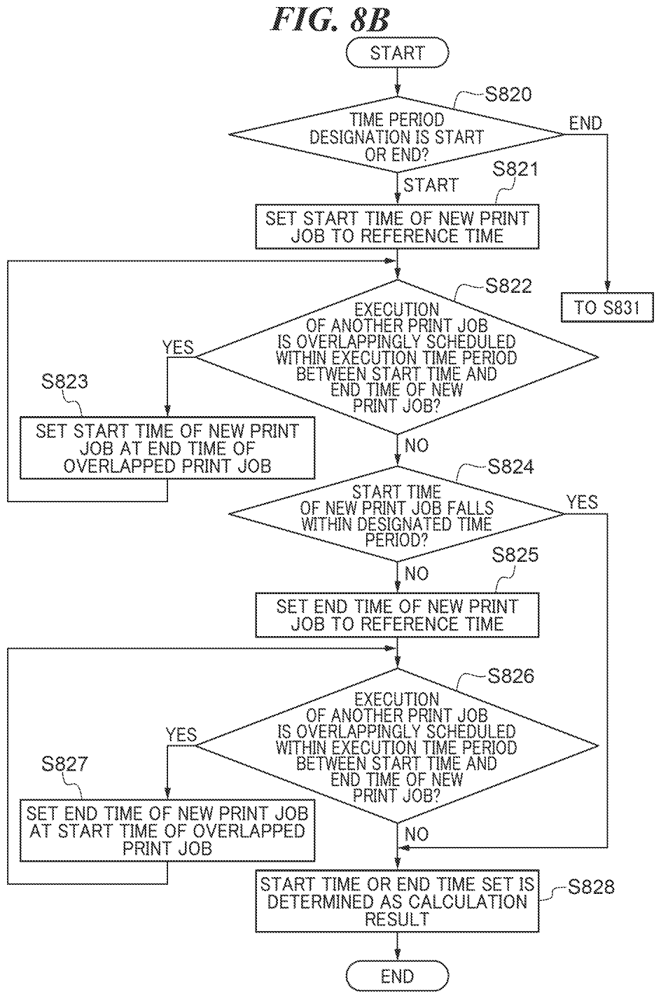

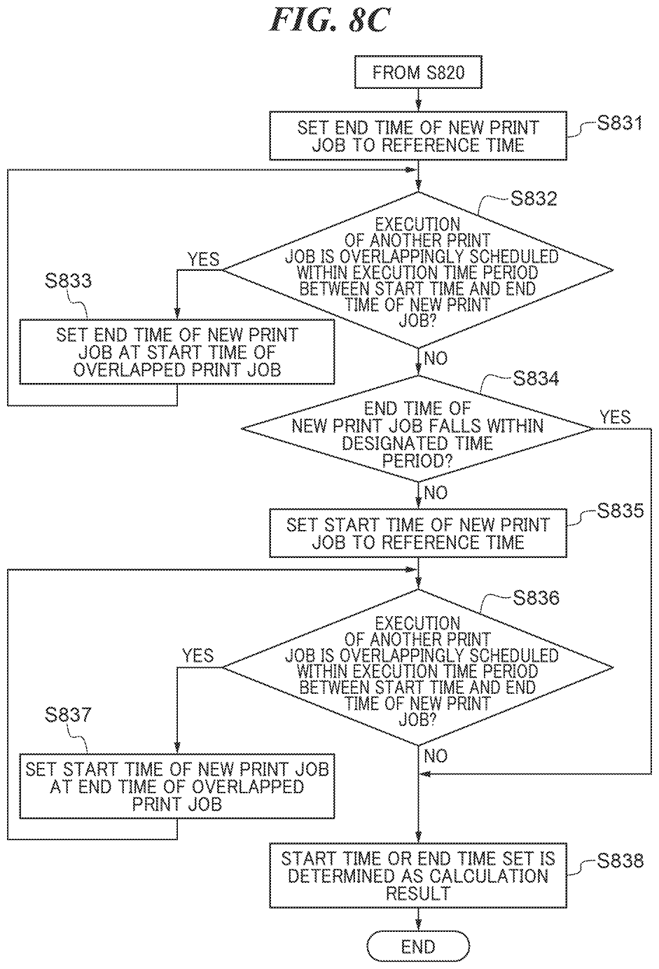

FIG. 8A is a flowchart showing a process executed by the printer. The flowchart shown in FIG. 8A shows the process from when the printer 200 receives a print job to when the printer 200 determines the execution time period (defined by the start time and the end time) of the print job. In the printer 200, schedule information about time designation of each print job is stored in the disk device 210 etc. Here, the time designation in a print job is at least one of formats, such as a start time period designation, an end time period designation, a start time designation, an end time designation, and no designation. As shown in FIG. 8A, the CPU 201 receives a print job via the communication unit 204 in a step S801.

In a step S802, the CPU 201 calculates the required time of the print job and stores the calculation result in the disk device 210 etc.

In a step S803, the CPU 201 determines the format of the time designation in the print job. As a result of the determination in the step S803, when the format of the time designation is determined as the start time designation format or the end time designation format, the process proceeds to a step S804. When the format of the time designation is determined as the start time designation format or the end time designation format, the process proceeds to a step S811. when it is determined that the format of the time designation is not determined, the process proceeds to a step S813.

In the step S804, the CPU 201 obtains the time period information 506 from the disk device 210 etc.

In a step S805, the CPU 201 determines whether there is time period information that matches the designated time period obtained in the step S804 in the time period information 506 obtained in the step S803. As a result of the determination in the step S805, when it is determined that there is matching time period information, the process proceeds to the step S806. In the meantime, when it is determined in the step S805 that there is no matching time period information, the process proceeds to the step S815.

In the step S806, the CPU 201 determines a reference time and a designated time period.

In the step S807, the CPU 201 calculates the execution start or end time of the print job according to the reference time determined in the step S806. In this calculation, when the execution time period of the print job overlaps the execution time period of another print job, the execution time period of the print job is scheduled before or after the execution time period of another print job.

For example, as shown in FIG. 7B and FIG. 7D, when the execution time period of the print job 4 cannot be scheduled after the reference time, the execution time period of the print job 4 is scheduled before the reference time. On the contrary, for example, when the execution time period of the predetermined print job cannot scheduled before the reference time, the execution time period of the predetermined print job may be scheduled after the reference time. Further, the execution time period of the predetermined print job may be scheduled to be closest to the reference time before or after the reference time. The details of the step S807 will be described later with reference to FIG. 8B and FIG. 8C.

In a step S808, the CPU 201 determines whether the calculation result in the step S807 falls within the designated time period. As a result of the determination in the step S808, when it is determined that the calculation result falls within the designated time period, the process proceeds to a step S809. In the meantime, as a result of the determination in the step S808, when it is determined that the calculation result does not fall within the designated time period, the process proceeds to the step S815.

In the step S809, the CPU 201 determines the calculation result in the step S807 as the start or end time of the print job.

In a step S810, the CPU 201 schedules the execution time period on the basis of the determined start or end time of the print job and records it in the schedule information.

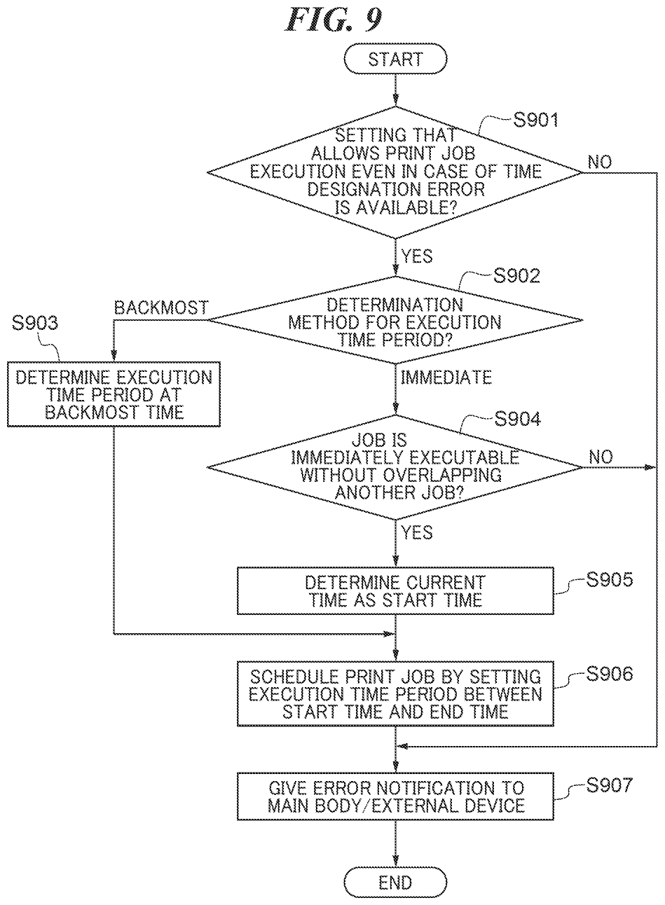

In the step S815, the CPU 201 performs a time designation error process. The details of the step S815 will be described later with reference to FIG. 9.

In the step S811 after execution of the step S803, the CPU 201 determines whether the print job is executable at the designated time without overlapping another print job. As a result of the determination in the step S811, when it is determined that the job is executable, the process proceeds to a step S812. In the meantime, as a result of the determination in the step S811, when it is determined that the job is not executable, the process proceeds to the step S815.

In the step S812, the CPU 201 determines the designated time as the start or end time of the print job, and the process proceeds to the step S810.

In the step S813 after execution of the step S803, the CPU 201 determines whether the print job is immediately executable without overlapping another print job. As a result of the determination in the step S813, when it is determined that the job is immediately executable, the process proceeds to a step S814. In the meantime, as a result of the determination in the step S813, when it is determined that the job is not executable immediately, the process proceeds to the step S815.

In the step S814, the CPU 201 determines the current time as the start time of the print job and proceeds with the process to the step S810.

FIG. 8B and FIG. 8C are flowcharts showing the process in the step S807 (subroutine) in the flowchart shown in FIG. 8A. In these flowcharts, when the execution time period of the predetermined print job cannot be scheduled after the reference time, the execution time period of the predetermined print job is scheduled before the reference time. Here, the received print job is referred to as a “new print job”.

As shown in FIG. 8B, in a step S820, the CPU 201 determines whether the time period designated for the new print job is a start time period or an end time period. As a result of the determination in the step S820, when it is determined that the time period is the start time period, the process proceeds to a step S821. In the meantime, as a result of the determination in the step S820, when it is determined that the time period is the end time period, the process proceeds to a step S831 (see FIG. 8C).

In the step S821, the CPU 201 sets the start time of the new print job to the reference time.

In a step S822, the CPU 201 determines whether another print job to be executed in the execution time period between the start time and the end time of the new print job is overlappingly scheduled. As a result of the determination in the step S822, when it is determined that the other job is overlappingly scheduled, the process proceeds to a step S823. In the meantime, as a result of the determination in the step S822, when it is determined that no other job is overlappingly scheduled, the process proceeds to a step S824.

In the step S823, the CPU 201 sets the start time of the new print job to the end time of the other print job that is overlapped. After the execution of the step S823, the process returns to the step S822 and the subsequent processes are executed in order.

In the step S824, the CPU 201 determines whether the start time of the new print job set in the step S823 falls within the designated time period indicated in the time period information 506 obtained in the step S804. As a result of the determination in the step S824, when it is determined that the start time of the new print job falls within the designated time period, the process proceeds to a step S828. In the meantime, as a result of the determination in the step S824, when it is determined that the start time of the new print job does not fall within the designated time period, the process proceeds to a step S825.

In the step S825, the CPU 201 sets the end time of the new print job to the reference time.

In a step S826, the CPU 201 determines whether another print job to be executed in the execution time period between the start time and the end time of the new print job is overlappingly scheduled. As a result of the determination in the step S826, when it is determined that the other print job is overlappingly scheduled, the process proceeds to a step S827. In the meantime, as a result of the determination in the step S826, when it is determined that no other print job is overlappingly scheduled, the process proceeds to the step S828.

In the step S827, the CPU 201 sets the end time of the new print job to the start time of the other print job that is overlapped. After the execution of the step S827, the process returns to the step S826, and the subsequent processes are executed in order.

In the step S828, the CPU 201 determines the set start or end time of the new print job as the calculation result.

As shown in FIG. 8C, in the step S831 after executing the step S820, the CPU 201 sets the end time of the new print job to the reference time.

In a step S832, the CPU 201 determines whether another print job to be executed in the execution time period between the start time and the end time of the new print job is overlappingly scheduled. As a result of the determination in the step S832, when it is determined that the other job is overlappingly scheduled, the process proceeds to the step S833. In the meantime, as a result of the determination in the step S832, when it is determined that no other job is overlappingly scheduled, the process proceeds to a step S834.

In the step S833, the CPU 201 sets the end time of the new print job to the start time of the other print job that is overlapped. After the execution of the step S833, the process returns to the step S832, and the subsequent processes are executed in order.

In the step S834, the CPU 201 determines whether the end time of the new print job set in the step S833 falls within the designated time period indicated by the time period information 506 obtained in the step S804. As a result of the determination in the step S834, when it is determined that the start time of the new print job falls within the designated time period, the process proceeds to a step S838. In the meantime, as a result of the determination in the step S834, when it is determined in step S834 that the start time of the new print job does not fall within the designated time period, the process proceeds to a step S835.

In the step S835, the CPU 201 sets the start time of the new print job to the reference time.

In a step S836, the CPU 201 determines whether another print job to be executed in the execution time period between the start time and the end time of the new print job is overlappingly scheduled. As a result of the determination in the step S836, when it is determined that the other job is overlappingly scheduled, the process proceeds to a step S837. In the meantime, as a result of the determination in the step S836, when it is determined that no other job is overlappingly scheduled, the process proceeds to a step S838.

In the step S837, the CPU 201 sets the start time of the new print job to the end time of the other print job that is overlapped. After the execution of the step S837, the process returns to the step S836, and the subsequent processes are executed in order.

In the step S838, the CPU 201 determines the set start or end time of the new print job as the calculation result.

According to the flowcharts shown in FIG. 8A to FIG. 8C as described above, for example, the timing charts shown in FIG. 7B and FIG. 7D are obtained.

FIG. 9 is a flowchart showing the process in the step S815 (subroutine) in the flowchart shown in FIG. 8A. As described above, in the flowchart shown in FIG. 8A, when the CPU 201 determines in the step S805 that there is no time period information that matches the time period designation in the time period information 506, or when the CPU 201 determines in the step S811 or S813 that the job overlaps another job, the process proceeds to the step S815, that is, a step S901.

As shown in FIG. 9, in the step S901, the CPU 201 determines whether a print job execution setting that allows execution of the print job even in a case of a time designation error, such as a case where it is determined that there is no matching time period information, is available. The setting information is held in the disk device 210 etc. Then, as a result of the determination in the step S901, when it is determined that the print job execution setting is available, the process proceeds to a step S902. In the meantime, as a result of the determination in the step S901, when it is determined that the print job execution setting is not available, the process proceeds to a step S907.

In the step S902, the CPU 201 determines a method for determining the execution time period of the print job. The determination method is not particularly limited. In this example, a method of scheduling the execution time period of the print job at the backmost time of the schedule information or a method of immediately scheduling the execution time period of the print job at the current time is used.

Then, as a result of the determination in the step S902, when the method of scheduling the execution time period of the print job at the backmost time of the schedule information is employed as the determination method, the process proceeds to a step S903. In the meantime, as a result of the determination in the step S902, when it is determined that the method of immediately scheduling the execution time period at the current time is employed as the decision method, the process proceeds to a step S904.

In the step S903, the CPU 201 determines the execution time period of the print job to the backmost time so as not to overlap another print job and proceeds with the process to a step S906.

In the step S904, the CPU 201 determines whether the print job is immediately executable without overlapping another print job. As a result of the determination in the step S904, when it is determined that the job is immediately executable, the process proceeds to a step S905. In the meantime, as a result of the determination in the step S904, when it is determined that the job is not immediately executable, the process proceeds to the step S907.

In the step S905, the CPU 201 determines the current time as the start time of the print job.

In the step S906, the CPU 201 records the determined execution time period of the print job in the schedule information.

In the step S907, the CPU 201 gives an error notification. When the start time of the print job cannot be determined in the execution time period, the error notification (report) about this fact is given. This enables the user to recognize that the start time of the print job is not executable within the execution time period. The error notification method is not particularly limited. For example, a method of displaying an error message as an image on the display unit 206 of the printer 200, a method of using a sound emitted from a loudspeaker of the printer 200, or a method of using light emitted from a pilot lamp of the printer 200 may be employed. In addition, as another error notification method using a different notification unit (reporting unit), for example, a method of notifying an external device such as the terminal apparatus 100 via the communication unit 204 may be employed.

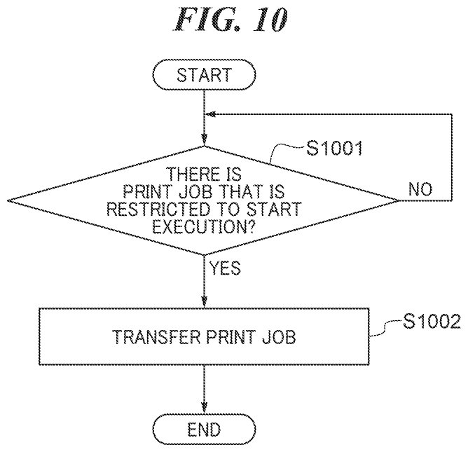

FIG. 10 is a flowchart showing a process performed in a case where there is a print job that is restricted to start execution. As described above, even when the printer 200 receives the print job 1 to the print job 6, the start of the execution of the print job 6 may be restricted (see FIG. 7B and FIG. 7D). In this case, there is a possibility that the printed matter of the print job 6 cannot be obtained. In the meantime, when a program based on the flowchart shown in FIG. 10 is executed, the printed matter of the print job 6 can be obtained.

As shown in FIG. 10, in a step 1001, the CPU 201 determines whether there is a print job that is restricted to start execution. As a result of the determination in the step S1001, when it is determined that there is such a print job, the process proceeds to a step S1002. In the meantime, as a result of the determination in the step S1001, when it is determined that there is no such a print job, the process waits in the step S1001 as is.

In the step 1002, the CPU 201 transfers the print job that is restricted to start execution to another printer different from printer 200. This print job is transferred within the execution time period. The other printer can execute the print job that is restricted to start execution, that is, the print job 6 within the execution time period. This enables to obtain a printed material of the print job 6. Instead of transferring the print job that is restricted to start execution or together with the transfer, a notification indicating that there is the print job that is restricted to start execution may be performed.

By performing control in this way, it is possible to maximally execute a print job having a timing to be executed by an easy operation.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-020847, filed Feb. 14, 2023, which is hereby incorporated by reference herein in its entirety.

What is claimed is:

1. A printer comprising:
a reception unit configured to receive a print job in which an execution time period for executing printing is designated;
an execution unit configured to execute the print job;
an obtainment unit configured to obtain a required time required for execution of the print job; and
a determination unit configured to determine an execution timing of the print job within a printable time period in which the print job is executable by the execution unit based on the execution time period and the required time, in a case where the printable time period overlaps the execution time period.

2. The printer according to claim 1, wherein the determination unit determines the execution timing of the print job so that a start time at which the print job starts will fall within the printable time period and the execution time period.

3. The printer according to claim 1, wherein the determination unit determines the execution timing of the print job so that an end time at which the print job ends will fall within the printable time period and the execution time period.

4. The printer according to claim 1, wherein the reception unit receives print jobs of which execution time periods overlap, and
wherein the determination unit determines execution timings of the print jobs so that executions of the print jobs will not overlap in the printable time period.

5. The printer according to claim 4, wherein the determination unit determines the execution timings of the print jobs in order of reception of the print jobs by the reception unit.

6. The printer according to claim 5, wherein a reference time in middle of the printable time period is set in the printable time period, and
wherein the determination unit determines a start time at which the print job received first by the reception unit among the print jobs is started so as to be close to the reference time or to be the reference time as the execution timing of the print job received first.

7. The printer according to claim 6, wherein the determination unit determines a start time at which another print job subsequent to the print job received first among the print jobs is started so as to fall within a time period before the reference time or the time period after the reference time while giving priority to the time period after the reference time as an execution timing of the another print job.

8. The printer according to claim 5, wherein a reference time in middle of the printable time period is set in the printable time period, and
wherein the determination unit determines an end time at which the print job received first by the reception unit among the print jobs is ended so as to be close to the reference time or to be the reference time as the execution timing of the print job received first.

9. The printer according to claim 8, wherein the determination unit determines an end time at which another print job subsequent to the print job received first among the print jobs is ended so as to fall within a time period before the reference time or the time period after the reference time while giving priority to the time period after the reference time as an execution timing of the another print job.

10. The printer according to claim 1, wherein the reception unit receives print jobs of which execution time periods overlap, and
wherein the determination unit determines execution timings of print jobs that are adjacent to each other and are executed within the printable time period so that an end time at which a preceding print job ends will overlap a start time at which a subsequent print job starts among the print jobs.

11. The printer according to claim 1, further comprising a storage unit configured to store the printable time period,
wherein the storage unit stores printable time periods in advance, and
wherein the printable time periods have time periods that do not overlap at least partially.

12. The printer according to claim 1, further comprising a notification unit configured to give notification, in a case where the determination unit cannot determine the execution timing of the print job, about such a fact.

13. A control method for a printer comprising:
a reception step of receiving a print job in which an execution time period for executing printing is designated;
an execution step of executing the print job;
an obtainment step of obtaining a required time required for execution of the print job; and
a determination step of determining an execution timing of the print job within a printable time period in which the print job is executable by the execution unit based on the execution time period and the required time, in a case where the printable time period overlaps the execution time period.

14. A non-transitory computer-readable storage medium storing a control program causing a computer to execute a control method for a printer, the control method comprising:
a reception step of receiving a print job in which an execution time period for executing printing is designated;
an execution step of executing the print job;
an obtainment step of obtaining a required time required for execution of the print job; and
a determination step of determining an execution timing of the print job within a printable time period in which the print job is executable by the execution unit based on the execution time period and the required time, in a case where the printable time period overlaps the execution time period.
